(19) United States
(12) Patent Application Publication
(10) Pub. No.: US 2007/0235979 A1
(43) Pub. Date: Oct. 11, 2007

(54) Bicycle with a pivotable support unit usable as a rear rack and a stand

(76) Inventor: Wesley Lin, Taichung Hsien (TW)

Correspondence Address: HARNESS, DICKEY & PIERCE, P.L.C., P.O. BOX 8910, RESTON, VA, 20195, US

(21) Appl. No.: 11/400,370

(22) Filed: Apr. 10, 2006

(51) Int. Cl. B62H 7/00

(52) U.S. Cl. 280/293; 280/298

(57) ABSTRACT

A bicycle includes a rear wheel rotatably mounted on a bicycle frame for rolling on a ground surface, a support unit pivotably mounted on the bicycle frame, and a locking unit disposed to releasably retain the support unit in a traveling position. The support unit includes a pivoted end, a shank member which extends from the pivoted end, and an elongated rail member connected to the shank member. The rail member has a supporting surface such that in a suspending position, the supporting surface is rested on the ground surface to suspend the rear wheel from the ground surface, and that when the support unit is turned to the traveling position, the rail member is turned to have the supporting surface face upwardly to serve as a rear rack of the bicycle.

### BACKGROUND OF THE INVENTION

1. Field of the Invention

This invention relates to a bicycle, more particularly to a bicycle having a support unit which is pivotally mounted on a bicycle frame that can be selectively used as a rear rack or a stand.

2. Description of the Related Art

Conventional bicycles are generally used as a means for transportation within a short distance, and thus can not provide sufficient exercise. For exercising purposes, the user may need to buy an indoor bicycle trainer which works by suspending the rear wheel of the bicycle off the ground surface, and providing resistance to the rear wheel through a resistance generating mechanism. However, such bicycle trainers are relatively expensive and inconvenient to install. Moreover, although a conventional bicycle stand can be used to suspend a rear wheel off the ground surface in a stationary position, it can not support the weight of a user sitting on the bicycle.

### SUMMARY OF THE INVENTION

The object of the present invention is to provide a bicycle which has a support unit that can be selectively used as a stand for suspending a rear wheel off a ground surface to enable the bicycle to be used as a stationary bicycle for exercising purposes, and as a rear rack for carrying

According to this invention, the bicycle includes a bicycle frame, front and rear wheels which are rotatably mounted on front and rear frame bodies of the bicycle frame, respectively, for rolling on a ground surface, a support unit which is pivotably mounted on the rear frame body about a pivot axis between a suspending position and a traveling position, and a locking unit which is disposed to releasably retain the support unit in the traveling position. The support unit includes a pivoted end which defines the pivot axis, a shank member which extends from the pivoted end in a radial direction relative to the pivot axis and which terminates at a connected end, and a rail member which is connected to and which is disposed to be transverse to the connected end and which is elongated in the longitudinal direction when the support unit is in the suspending and traveling positions. The rail member has a supporting surface, and is configured such that in the suspending position, the supporting surface is rested on the ground surface so as to suspend the rear wheel from the ground surface, and such that when the support unit is turned to the traveling position, the rail member is turned therewith such that the supporting surface faces upwardly, thereby enabling the support unit to serve as a rear rack.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic side view of the first preferred embodiment of a bicycle according to this invention, showing a support unit in a traveling position;

FIG. 2 is a fragmentary, partly-sectioned enlarged view of an encircled portion in FIG. 1 when a locking unit in a locked position;

FIG. 3 is a view similar to FIG. 2, but showing the locking unit in an unlocked position;

FIG. 4 is a view similar to FIG. 3, but showing a connecting rod of the locking unit which is disengaged from a mount seat;

FIG. 5 is a view similar to FIG. 1, but showing the support unit in a suspending position;

FIG. 6 is a fragmentary, partly-sectioned enlarged view of the second preferred embodiment of a bicycle according to this invention, showing a locking unit in a locked position;

FIG. 7 is a view similar to FIG. 6, but showing the locking unit in an unlocked position;

FIG. 8 is a fragmentary, partly-sectioned enlarged view of the third preferred embodiment of a bicycle according to this invention, showing a locking unit in a locked position;

FIG. 9 is a view similar to FIG. 8, but showing the locking unit in an unlocked position;

FIG. 10 is a fragmentary, partly-sectioned enlarged view of the fourth preferred embodiment of a bicycle according to this invention, showing a locking unit in a locked position;

FIG. 11 is a fragmentary cross-sectional view taken along lines 11-11 of FIG. 10;

FIG. 12 is a view similar to FIG. 10, but showing the locking unit in an unlocked position;

FIG. 13 is a schematic rear view of the fifth preferred embodiment of a bicycle according to this invention, showing a support unit in a traveling position;

FIG. 14 is a fragmentary schematic side view of the fifth preferred embodiment;

FIG. 15 is a view similar to FIG. 13, but showing a locking unit in an unlocked position;

FIG. 16 is a view similar to FIG. 13, but showing the support unit in a suspending position; and

FIG. 17 is a view similar to FIG. 13, but showing the support unit in the suspending position and the locking unit in a locked position.

### DETAILED DESCRIPTION OF THE PREFERRED EMBODIMENTS

Before the present invention is described in greater detail, it should be noted that same reference numerals have been used to denote like elements throughout the specification.

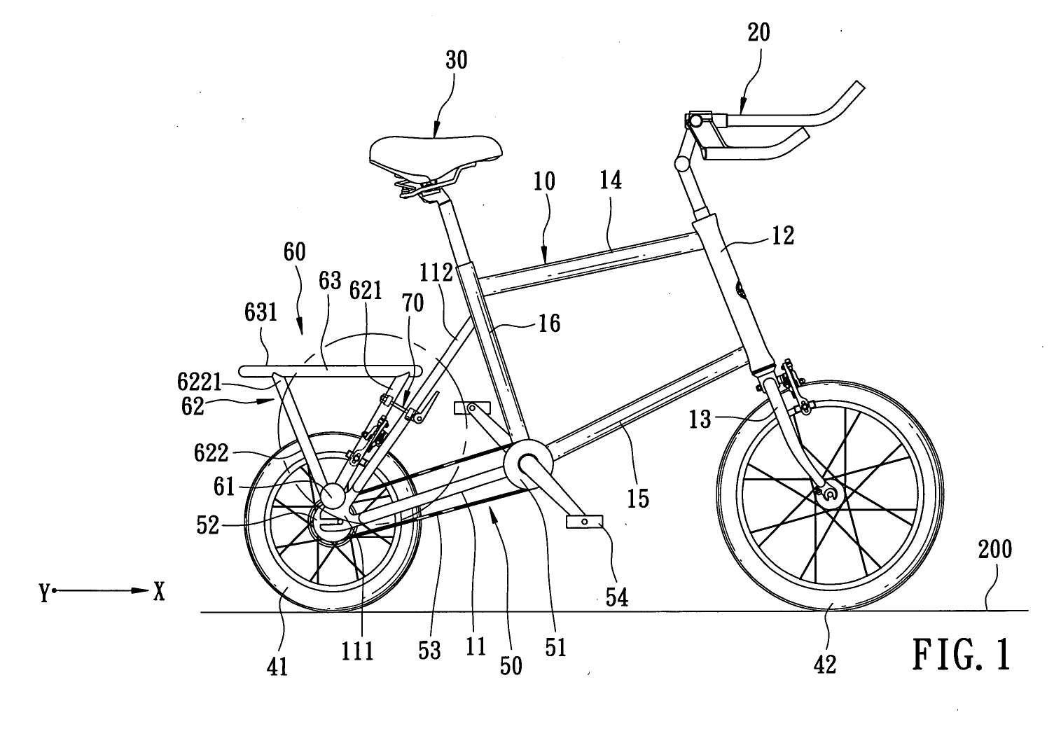

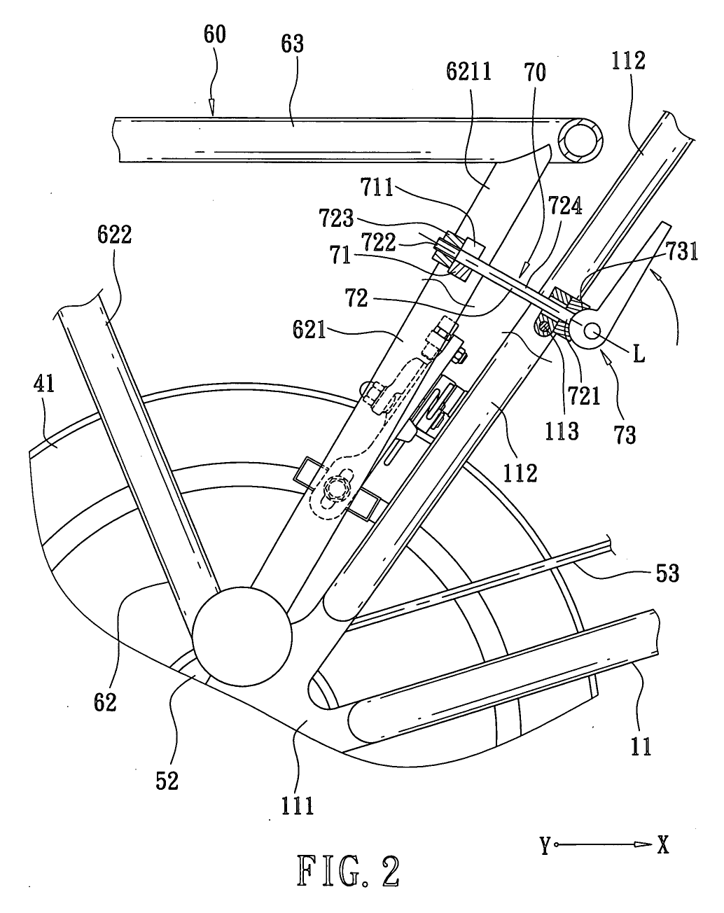

Referring to FIGS. 1 and 2, the first preferred embodiment of a bicycle according to the present invention is shown to comprise a bicycle frame 10, a handle 20, a seat member 30, front and rear wheels 42, 41, a driving unit 50, a support unit 60, and a locking unit 70.

The bicycle frame 10 includes front and rear frame bodies opposite to each other in a longitudinal direction (X). The front frame body includes a head tube 12, a front fork 13 connected to the head tube 12, upper and lower tubes 14, 15 connected to the head tube 12, a seat tube 16 connected to the upper tube 14, and a bottom tube (not visible) connected to the lower tube 15 and the seat tube 16. The rear frame body includes a rear fork 11 having two spaced apart rear fork ends 111, two rear upper fork shafts 112 which respectively extend from the rear fork ends 111, and a connecting bar 113 (see FIG. 2) which interconnects the rear upper fork shafts 112. The handle 20 is mounted on the head tube 12 for steering the bicycle. The seat member 30 is mounted on the seat tube 16.

The front and rear wheels 42, 41 are rotatably mounted on the front fork 13 and the rear fork ends 111, respectively, for rolling on a ground surface 200. The driving unit 50 is mounted on the bicycle frame 10 to drive the rear wheel 41 to roll on the ground surface 200 about a rear wheel axis in a transverse direction (Y) relative to the longitudinal direction (X). The driving unit 50 includes a chain wheel 51, a sprocket 52 disposed between the rear fork ends 111, a drive chain 53 trained on the chain wheel 51 and the sprocket 52, and a pedaling member 54 mounted on the bottom tube for pedaling by the rider.

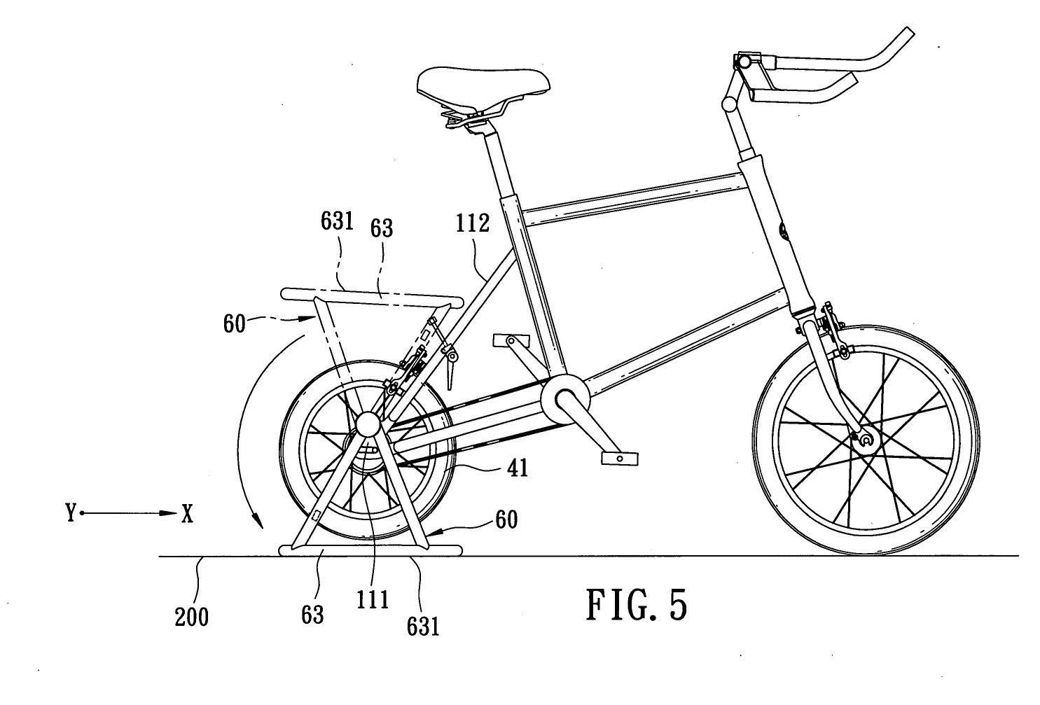

The support unit 60 is pivotably mounted on the rear fork ends 111 about a pivot axis between a suspending position and a traveling position. Specifically, the support unit 60 includes a pivoted end 61 which defines the pivot axis oriented in the transverse direction (Y) (i.e., parallel to the rear wheel axis), a pair of shank members 62 which extend from the pivoted end 61 in a radial direction relative to the pivot axis, and which are spaced apart from each other in the transverse direction (Y), and a rail member 63. Each of the shank members 62 includes front and rear shanks 621, 622 which extend from the pivoted end 61 to respectively terminate at connected ends 6211, 6221 and which diverge towards the rail member 63. The rail member 63 is connected to and is disposed transverse to the connected ends 6211, 6221 of the shank members 62, and is elongated in the longitudinal direction (X) when the support unit 60 is in the suspending and traveling positions. The rail member 63 has a supporting surface 631, and is configured such that when the support unit 60 is in the suspending position, as shown in FIG. 5, the supporting surface 631 is rested on the ground surface 200 so as to suspend the rear wheel 41 from the ground surface 200. When the support unit 60 is turned about the pivot axis to the traveling position, as shown in FIG. 1, the rail member 63 is turned therewith such that the supporting surface 631 faces upwardly, thereby enabling the support unit 60 to serve as a rear rack of the bicycle for carrying a load, such as a person, good, etc.

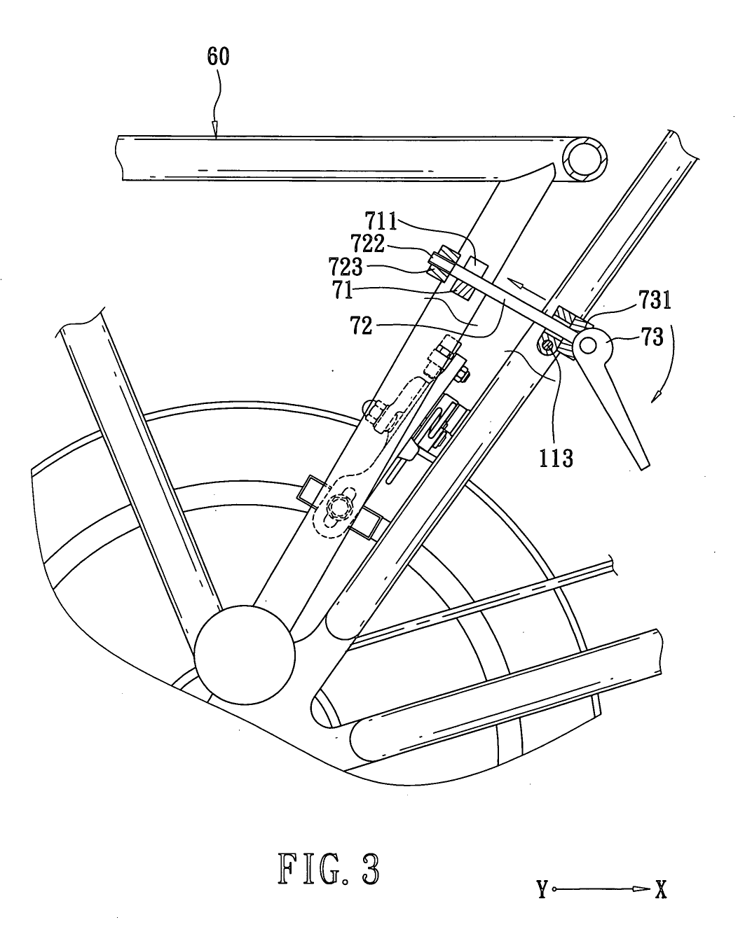

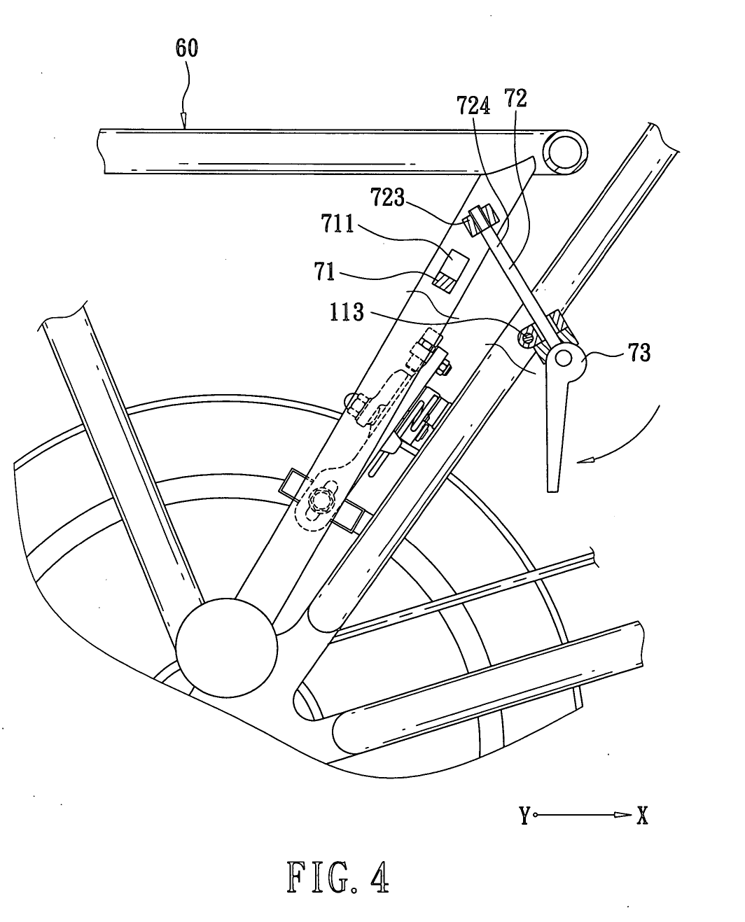

The locking unit 70 is a so-called “quick-released lock,” and is disposed to releasably retain the support unit 60 in the traveling position. In this embodiment, the locking unit 70 includes a mount seat 71, a connecting rod 72, and a cam member 73. The mount seat 71 is disposed between the front shanks 621, and has an upwardly opening retaining groove 711 which extends through the mount seat 71. The connecting rod 72 has an actuated end 721 which is mounted on and which is movable relative to the connecting bar 113, a connecting end 722 which is opposite to the actuated end 721 along a displacement line (L), an abutting wall 723 which is mounted on the connecting end 722 along the displacement line (L), and a middle segment 724 which is interposed between the connecting and actuated ends 722, 721, and which is disposed to be inserted into the upwardly opening retaining groove 711 when the support unit 61 is in the traveling position such that the abutting wall 723 is disposed rearwardly of and confronts the mount seat 71 along the displacement line (L). The cam member 73 is mounted on and is pivotable to the actuated end 721 about a cam axis which is transverse to the displacement line (L). The cam member 73 has a cam surface 731 such that when the cam member 73 is turned about the cam axis from an unlocked position (as shown in FIG. 3) to a locked position (as shown in FIG. 2), the abutting wall 723 is moved from a non-engaging or loosely engaging position, where the abutting wall 723 does not abut against the mount seat 71, to a tightly engaging position, where the abutting wall 723 abuts tightly against the mount seat 71. As shown in FIG. 4, when the cam member 73 is in the unlocked position, the middle segment 724 is rotatable to disengage from the retaining groove 711 so as to permit the support unit 60 to be turned to the suspending position (as shown in FIG. 5).

As illustrated, the support unit 60 is turnable between the suspending position and the traveling position. In the traveling position, the support unit 60 is retained relative to the bicycle frame 10 to be used as a rear rack for carrying a load. In the suspending position, the rail member 63 of the support unit 60 is rested on the ground surface 200 to suspend the rear wheel 41 from the ground surface 200, thereby enabling the bicycle to serve as a stationary bicycle for exercising purposes.

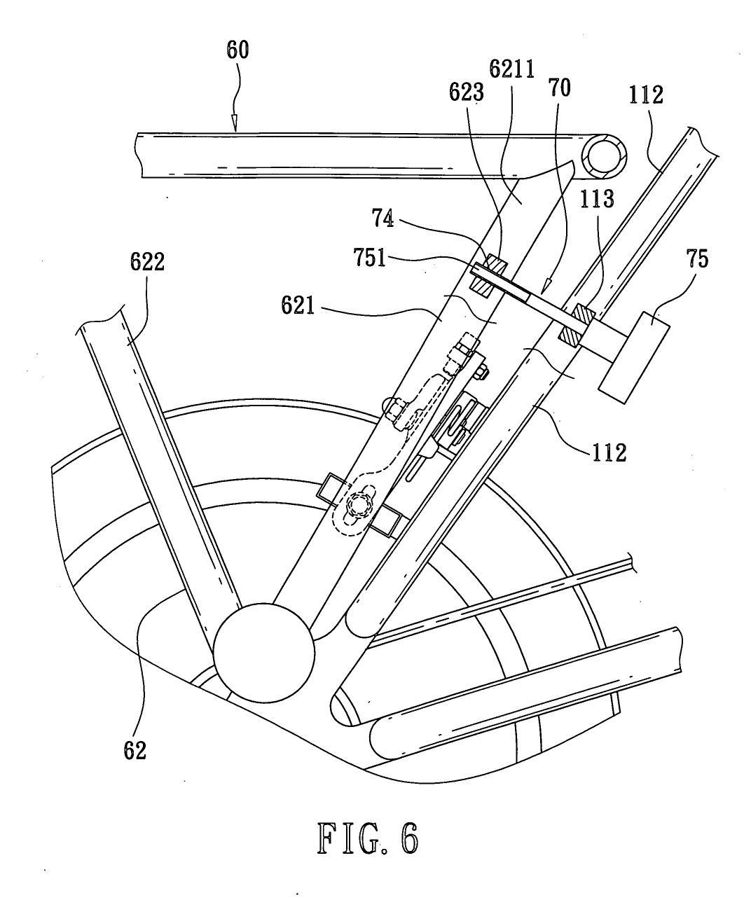

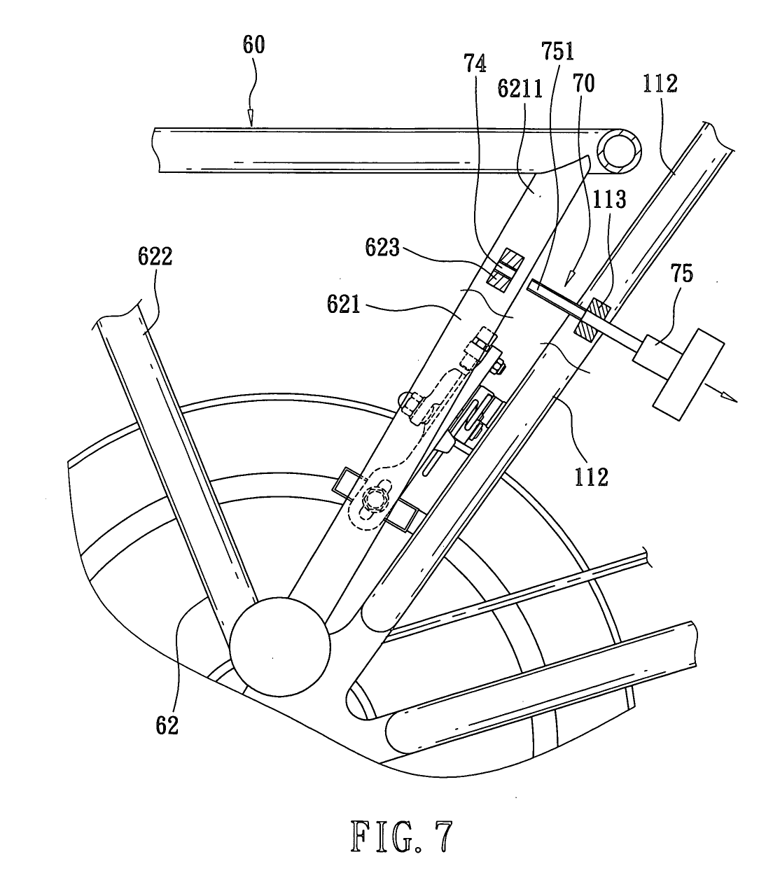

Referring to FIGS. 6 and 7, the second preferred embodiment of the bicycle according to this invention is similar to the first preferred embodiment in construction. In the second embodiment, a connecting bar 623 extends transversely to interconnect the front shanks 621. Moreover, the locking unit 70 includes a screw hole 74 which is formed in the connecting bar 623, and a screw bolt 75 which is mounted on and which is retainingly rotatable relative to the connecting bar 113 and which has a threaded portion 751 to threadedly engage the screw hole 74 when the support unit 60 is in the traveling position.

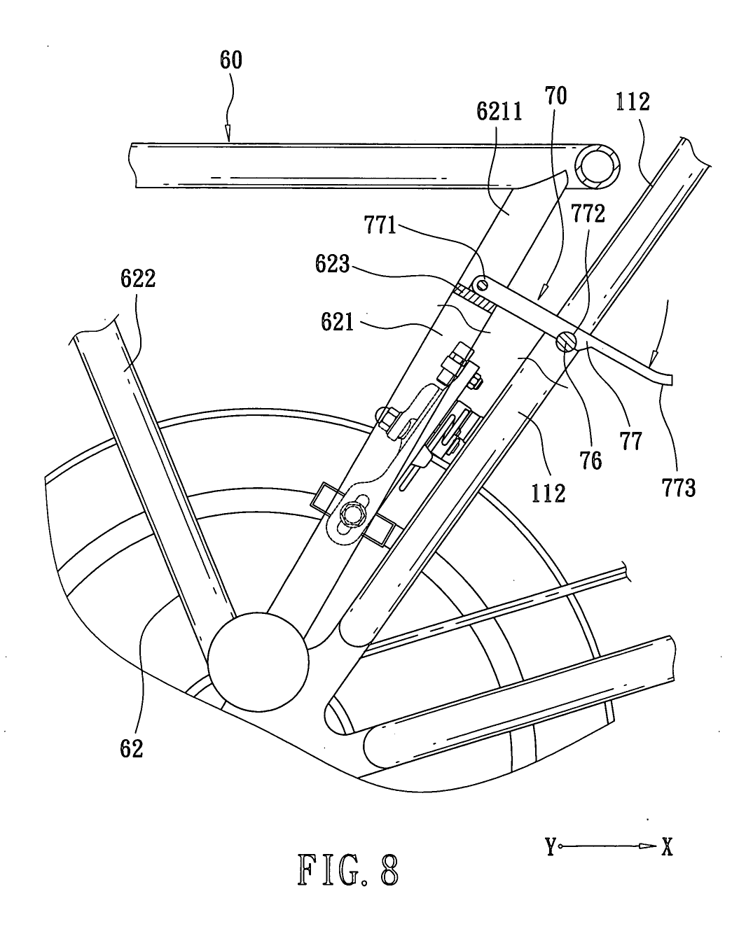

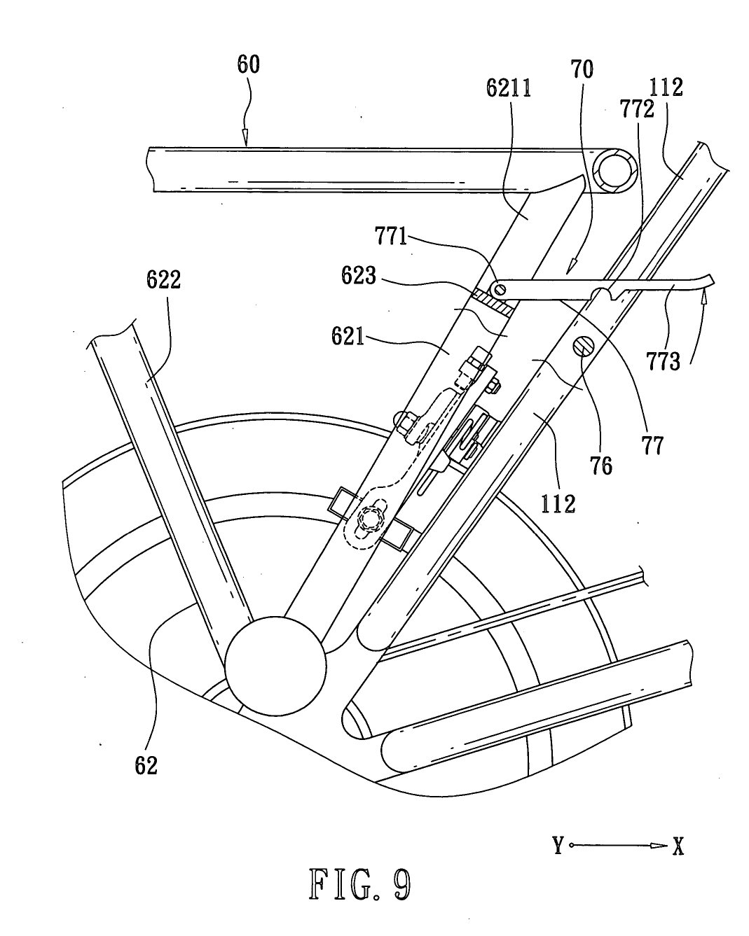

Referring to FIGS. 8 and 9, the third preferred embodiment of the bicycle according to this invention is similar to the second preferred embodiment in construction, except that the locking unit 70 includes an anchored stem 76 which is disposed between the rear upper fork shafts 112, and a lever 77 which has a pivot end 771 that is pivotally mounted on the connecting bar 623 about a rotating axis parallel to the rear wheel axis, and an anchoring portion 772 that extends from the pivot end 771 and that terminates at an operated end 773 such that when the support unit 60 is in the traveling position, the anchoring portion 772 is turnable about the rotating axis between a locking position, as shown in FIG. 8, where the anchoring portion 772 anchors the anchored stem 76, and an unlocking position, as shown in FIG. 8, where the anchoring portion 772 disengages from the anchored stem 76.

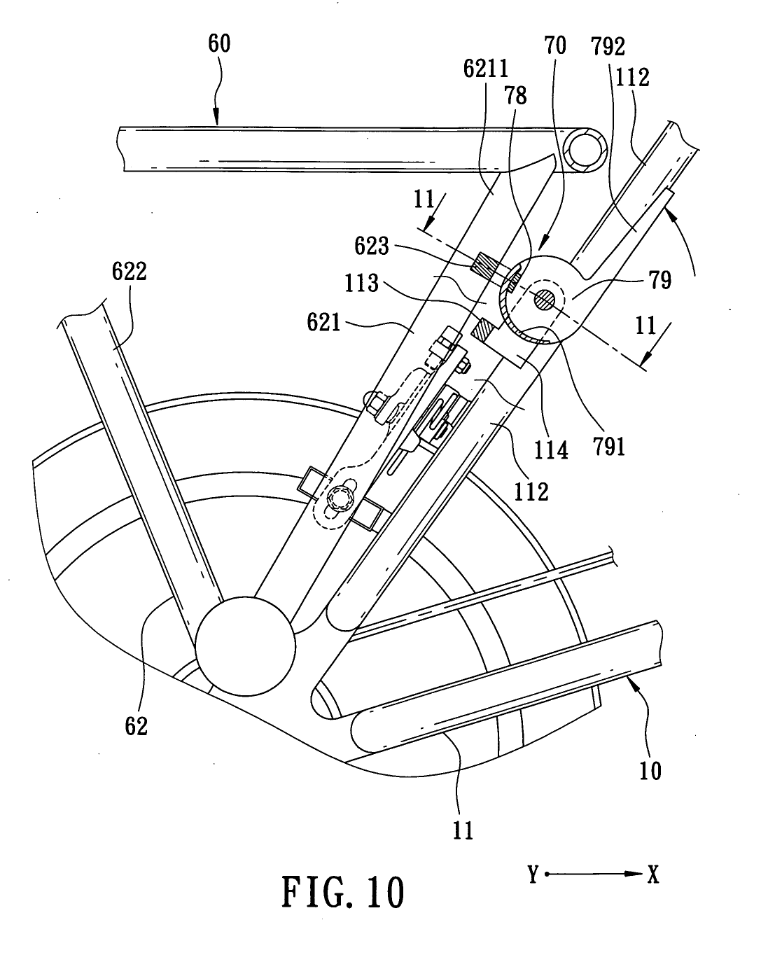

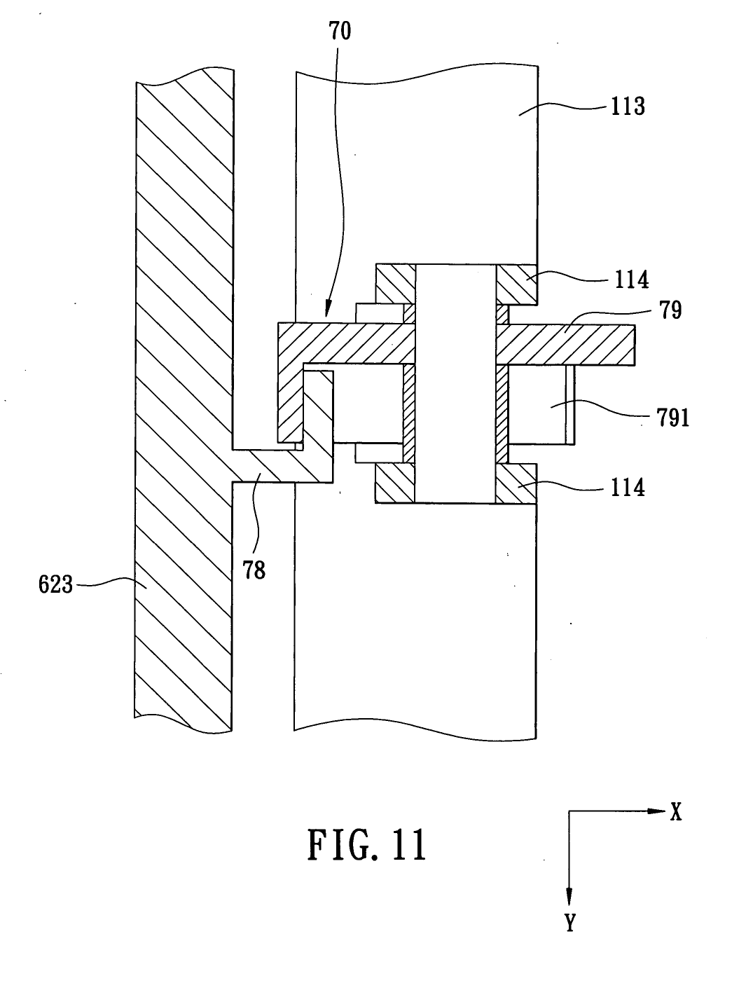

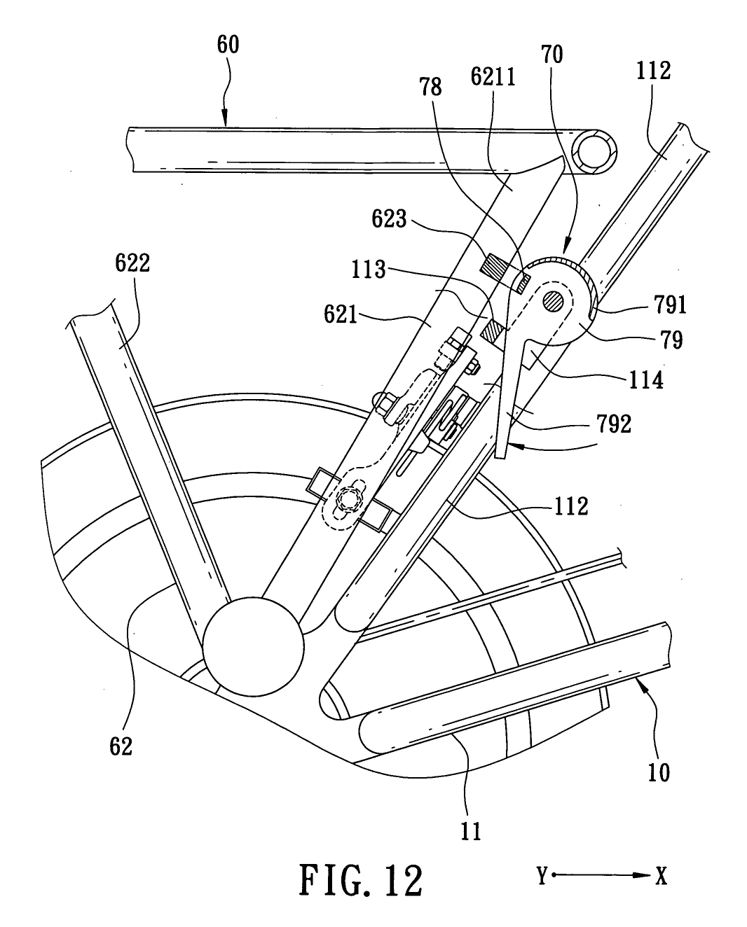

Referring to FIGS. 10 to 12, the fourth preferred embodiment of the bicycle according to this invention is similar to the third preferred embodiment in construction. In the fourth embodiment, the connecting bar 113 has a pair of spaced apart pivot lugs 114. The locking unit 70 includes a retaining lug 78 which is disposed on the connecting bar 623, and a rotary member 79 which is rotatably mounted on the pivot lugs 114 about a rotating axis parallel to the rear wheel axis and which has a cam surface 791 that extends angularly about the rotating axis, and an operating portion 792 that extends opposite to the cam surface 791. Thus, when the support unit 60 is in the traveling position, and once the rotary member 79 is turned about the rotating axis to bring the cam surface 791 into sliding engagement with the retaining lug 78, the retaining lug 78 is moved closer to the rotating axis, thereby tightening the engagement between the cam surface 791 and the retaining lug 78.

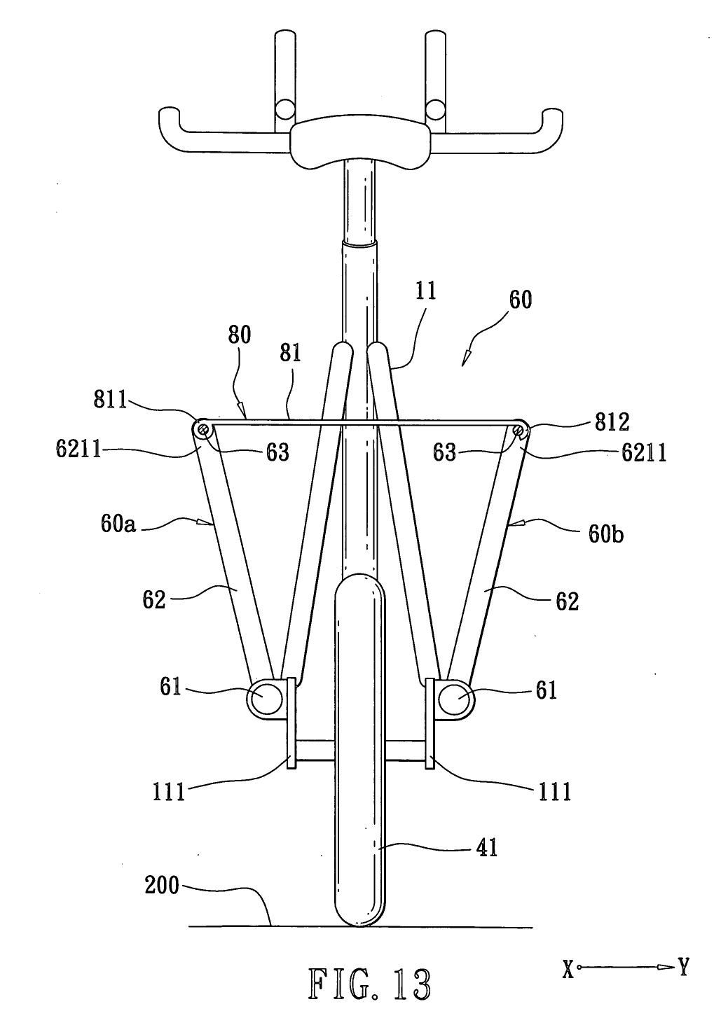

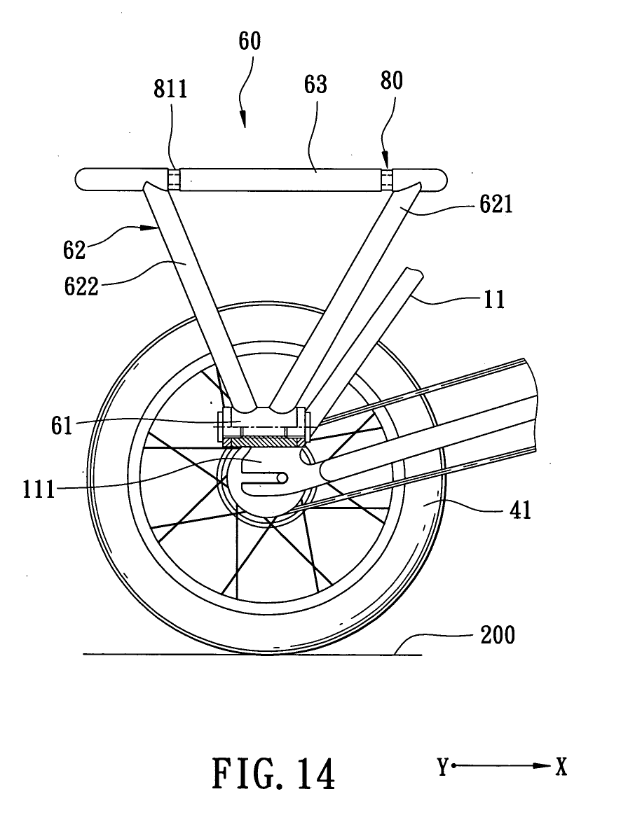

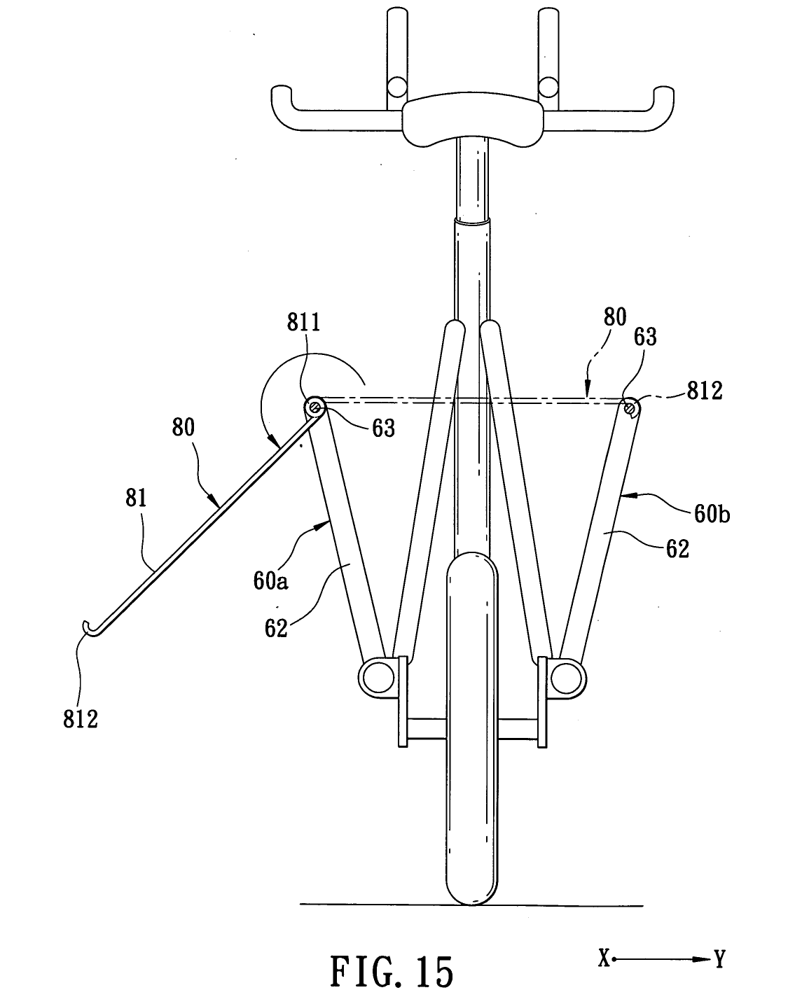

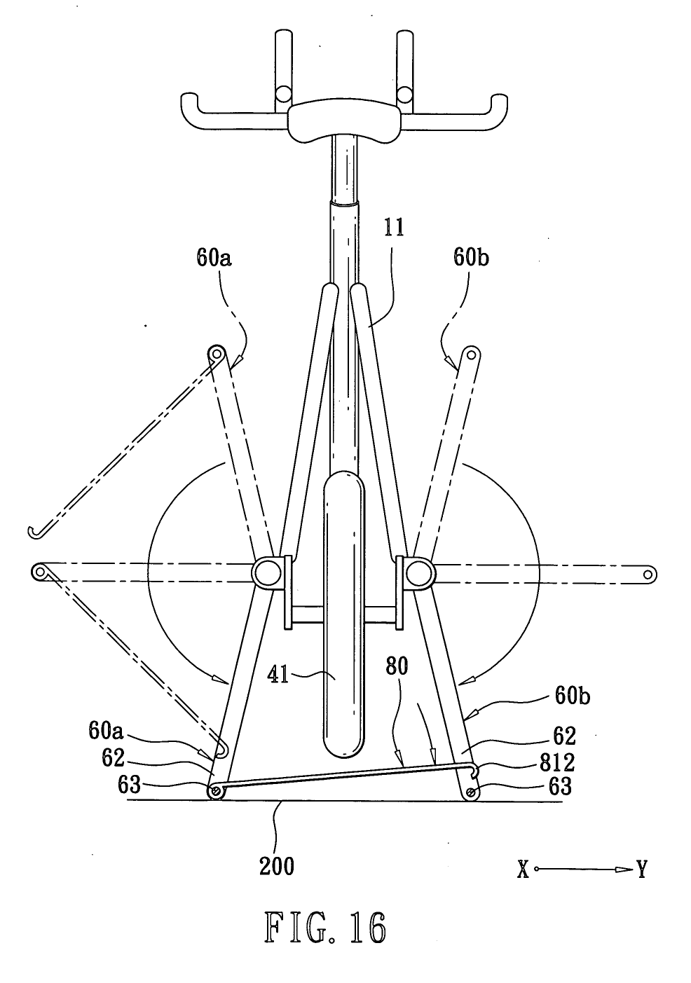

Referring to FIGS. 13 to 17, the fifth preferred embodiment of the bicycle according to this invention is similar to the first preferred embodiment in construction. In the fifth embodiment, the pivot axis about which the support unit 60 is pivoted is oriented in the longitudinal direction (X) and is transverse to a rear wheel axis of the rear wheel 41. Specifically, the support unit 60 includes left and right support frames (60a, 60b) which are opposite to each other in the transverse direction (Y). Each of the left and right support frames (60a, 60b) includes the pivoted end 61, the shank member 62, and the rail member 63. The shank member 62 of each of the left and right support frames (60a, 60b) includes front and rear shanks 621, 622 which extend from the pivoted end 61 and which diverge towards the rail member 63. Thus, the shank member 62 is swingable about the pivot axis while enabling the rail member 63 to be disposed outwardly and laterally of the rear fork 11.

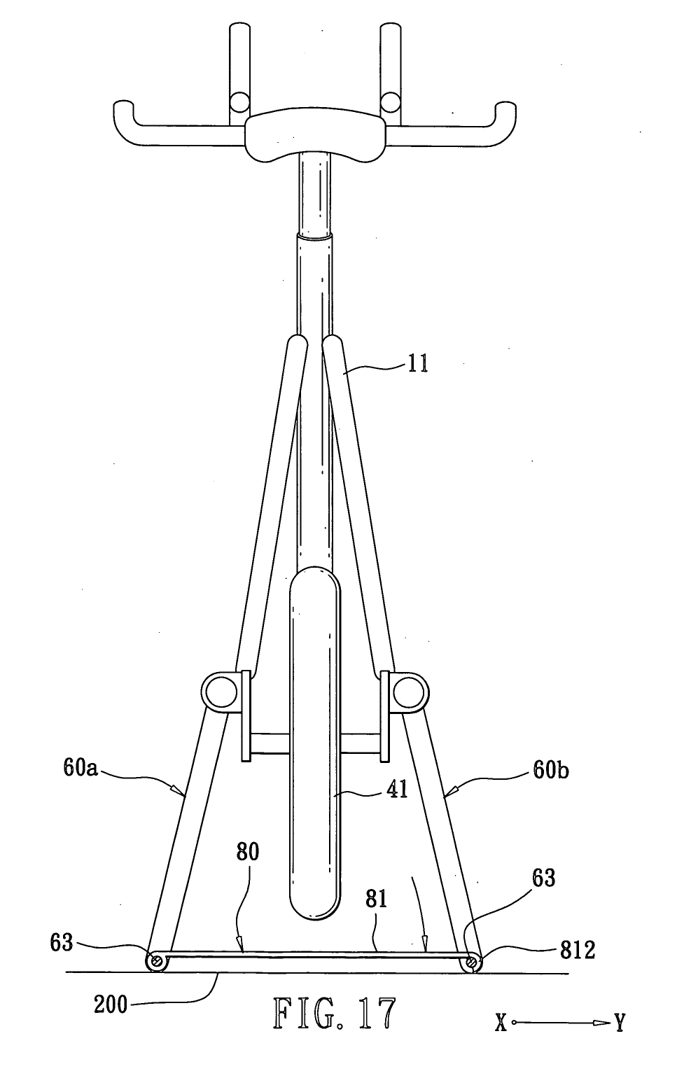

The locking unit 80 includes a bracing member 81 which has a hinged end 811 that is pivotally mounted on the rail member 63 of the left support frame (60a) about a hinge axis oriented in the longitudinal direction (X), and an anchoring end 812 that is opposite to the hinged end 811 and that is configured such that when the support unit 60 is in one of the suspending position (as shown in FIG. 17) and the traveling position (as shown in FIG. 13), the anchoring end 812 can anchor the rail member 63 of the right support frame (60b) so as to interconnect the left and right support frames (60a, 60b), thereby retaining the support unit 60 in the respective one of the suspending and traveling positions.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. A bicycle comprising:
a bicycle frame including front and rear frame bodies opposite to each other in a longitudinal direction;
front and rear wheels which are rotatably mounted on said front and rear frame bodies, respectively, for rolling on a ground surface;
a support unit pivotably mounted on said rear frame body about a pivot axis between a suspending position and a traveling position, said support unit including
a pivoted end which defines the pivot axis,
a shank member which extends from said pivoted end in a radial direction relative to the pivot axis and which terminates at a connected end, and
a rail member which is connected to and which is disposed transverse to said connected end, and which is elongated in the longitudinal direction when said support unit is in the suspending and traveling positions, said rail member having a supporting surface, and being configured such that when said support unit is in the suspending position, said supporting surface is rested on the ground surface so as to suspend said rear wheel from the ground surface, and such that when said support unit is turned about the pivot axis to the traveling position, said rail member is turned therewith such that said supporting surface faces upwardly, thereby enabling said support unit to serve as a rear rack; and
a locking unit which is disposed to releasably retain said support unit in the traveling position.

2. The bicycle of claim 1, wherein the pivot axis is oriented in a transverse direction relative to the longitudinal direction, and is parallel to a rear wheel axis about which said rear wheel is rotated.

3. The bicycle of claim 2, wherein said locking unit includes
a mount seat disposed on said shank member, and having an upwardly opening retaining groove which extends through said mount seat,
a connecting rod having an actuated end which is mounted on and which is movable relative to said rear frame body, a connecting end which is opposite to said actuated end along a displacement line, an abutting wall which is mounted on said connecting end along the displacement line, and a middle segment which is interposed between said connecting and actuated ends, and which is disposed to be inserted into said upwardly opening retaining groove when said support unit is in the traveling position, such that said abutting wall is disposed rearwardly of and confronts said mount seat along the displacement line, and
a cam member mounted on and pivotable to said actuated end about a cam axis which is transverse to the displacement line, said cam member having a cam surface which is configured such that when said cam member is turned about the cam axis from an unlocked position to a locked position, said abutting wall is moved from a non-engaging position, where said abutting wall does not abut against said mount seat, to a tightly engaging position, where said abutting wall abuts tightly against said mount seat.

4. The bicycle of claim 2, wherein said locking unit includes a screw hole which is formed in said shank member, and a screw bolt which is mounted on and which is retainingly rotatable relative to said rear frame body and which is configured to threadedly engage said screw hole when said support unit is in the traveling position.

5. The bicycle of claim 2, wherein said locking unit includes an anchored stem which is disposed on and which extends from said rear frame body, and a lever which has a pivot end that is pivotally mounted on said shank member about a rotating axis parallel to the rear wheel axis, and an anchoring portion that extends from said pivot end and that terminates at an operated end such that when said support unit is in the traveling position, said anchoring portion is turnable about the rotating axis between a locking position, where said anchoring portion anchors said anchored stem, and an unlocking position, where said anchoring portion disengages from said anchored stem.

6. The bicycle of claim 2, wherein said locking unit includes a retaining lug which is disposed on said shank member, and a rotary member which is rotatably mounted on said rear frame body about a rotating axis parallel to the rear wheel axis and which has a cam surface that extends angularly about the rotating axis such that when said support unit is in the traveling position, and once said rotary member is turned about the rotating axis to bring said cam surface into sliding engagement with said retaining lug, said retaining lug is moved closer to the rotating axis, thereby tightening the engagement between said cam surface and said retaining lug.

7. The bicycle of claim 1, wherein said shank member includes front and rear shanks which extend from said pivoted end and which diverge towards said rail member.

8. The bicycle of claim 1, wherein the pivot axis is oriented in the longitudinal direction and is transverse to a rear wheel axis about which said rear wheel is rotated such that said shank member is swingable about the pivot axis while enabling said rail member to be disposed outwardly and laterally of said rear frame body.

9. The bicycle of claim 1, wherein said support unit includes left and right support frames which are opposite to each other in a transverse direction relative to the longitudinal direction, each of said left and right support frames including said pivoted end, said shank member, and said rail member.

10. The bicycle of claim 9, wherein said locking unit includes a bracing member which has a hinged end that is pivotally mounted on said rail member of said left support frame about a hinge axis oriented in the longitudinal direction, and an anchoring end that is opposite to said hinged end and that is configured such that when said support unit is in one of the suspending and traveling positions, said anchoring end can anchor said rail member of said right support frame to interconnect said left and right support frames so as to retain said support unit in said one of the suspending and traveling positions.

11. The bicycle of claim 10, wherein said shank member of each of said left and right support frames includes front and rear shanks which extend from said pivoted end and which diverge towards said rail member.
